(19) United States
(12) Patent Application Publication
(10) Pub. No.: US 2024/0306143 A1
(43) Pub. Date: Sep. 12, 2024

(54) COEXISTENCE BETWEEN COMMUNICATIONS IN ADJACENT FREQUENCY BAND

(71) Applicant: QUALCOMM Incorporated, San Diego, CA (US)

(72) Inventors: Lianghai JI, San Diego, CA (US); Jun MA, San Diego, CA (US); Alexander DOROSENCO, El Cajon, CA (US); Liang ZHAO, Saratoga, CA (US); David TUCK, San Juan Capistrano, CA (US); Jordan COOKMAN, San Jose, CA (US); Angelica WONG, Palo Alto, CA (US); Liangping MA, San Diego, CA (US); Mohamad SAYED HASSAN, Paris (FR); Qiang WU, San Diego, CA (US); Mehmet Izzet GURELLI, San Diego, CA (US)

(21) Appl. No.: 18/178,946

(22) Filed: Mar. 6, 2023

(51) Int. Cl. H04W 72/12; H04W 72/563

(52) U.S. Cl. CPC H04W 72/1215; H04W 72/563; H04W 88/06

(57) ABSTRACT

Certain aspects of the present disclosure provide techniques reducing wireless interference in wireless communications networks by, for example, enabling a coexistence period during which transmission over a first wireless communication band is deprioritized and reception over a second wireless communication band, different from the first wireless communication band, is prioritized; and receiving positioning data from a positioning system via the second wireless communication band during the coexistence period.

### BACKGROUND

### Field of the Disclosure

Aspects of the present disclosure relate to wireless communications, and more particularly, to techniques for reducing wireless interference for communications in adjacent frequency bands.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for reducing wireless interference at a user equipment. The method includes enabling a coexistence period during which transmission over a first wireless communication band is deprioritized and reception over a second wireless communication band, different from the first wireless communication band, is prioritized; and receiving positioning data from a positioning system via the second wireless communication band during the coexistence period.

Another aspect provides a method for reducing wireless interference. The method includes sending, to a user equipment, a configuration for a coexistence period during which transmission over a first wireless communication band is deprioritized and downlink communication over a second wireless communication band, different from the first wireless communication band, is prioritized.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example of multi-band communications in a non-terrestrial network.

FIG. 6 depicts an example of various wireless communications bands that may be used in multi-band communications in non-terrestrial network.

FIG. 7 depicts example operations of using coexistence periods in a wireless communication network.

FIG. 8 depicts further example operations of using coexistence periods in a wireless communication network.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for reducing wireless interference in wireless communication networks.

A non-terrestrial network (NTN) generally provides wireless communication service to areas where terrestrial network service is not available. In an NTN, various types of vehicles, including airborne and space-borne vehicles, such as a satellite, balloon, aircraft, drone, etc., may be used as network entities to communicate with user equipments (UEs). NTNs may be implemented as extensions to, or otherwise aspects of, an existing wireless communication network, such as a terrestrial wireless communication network, like a cellular network. In this way, NTNs may greatly increase the coverage of wireless communication networks generally.

UEs also utilize signals from other types of non-terrestrial vehicles for enhanced operations, such as receiving global navigation satellite system (GNSS) signals for performing precise location determination. Precise location determination is in-turn used to support many network functions, such as frequency and time synchronization between a UE and a network entity.

The wireless spectrum over which UEs may communicate with terrestrial and non-terrestrial network entities in a wireless communication network is both limited and regulated. Further, specific wireless communications bands are often reserved for specific types of wireless communications. Thus, there is generally a technical challenge of maximizing use of the wireless spectrum while avoiding interference in the wireless spectrum given its many uses.

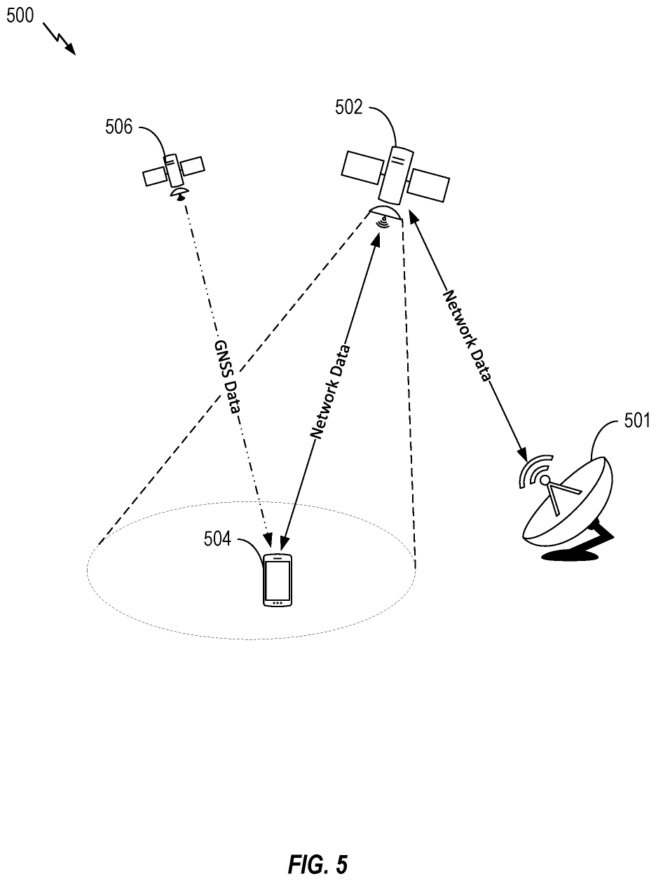

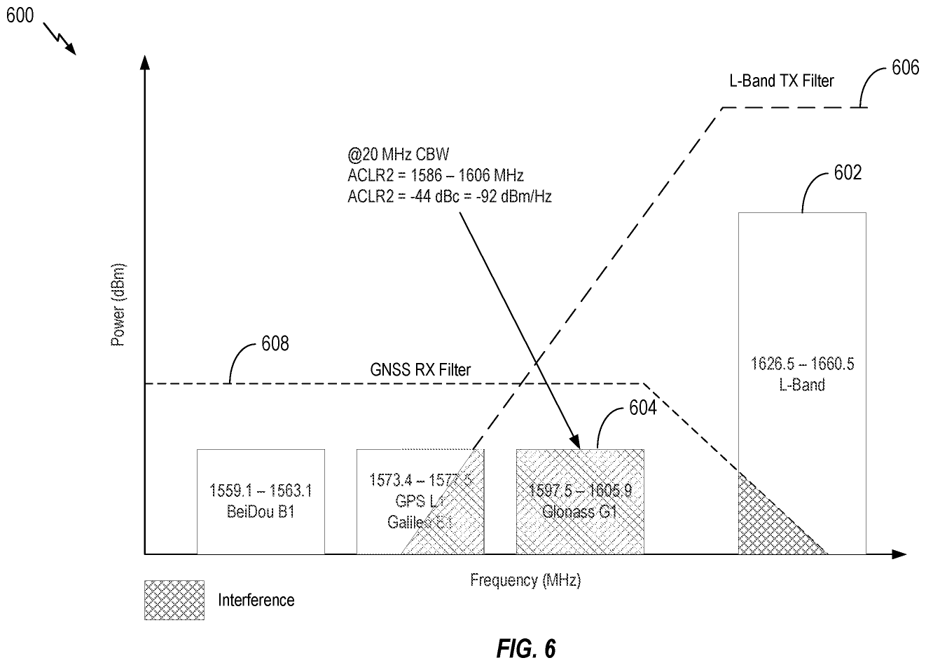

A technical problem arises when a first type of wireless communication (e.g., using a first wireless communication band) between a UE and a non-terrestrial network entity (e.g., within an NTN) causes wireless interference with a second type of wireless communication (e.g., using a second wireless communication band) between the UE and another entity. In other words, a coexistence problem exists when the UE tries to utilize the two wireless communication bands concurrently. Consider the example in which a UE communicates with a non-terrestrial network entity, such as a satellite, for voice and data over the L-band spectrum, e.g. between 1626.5 MHz and 1660.5 MHz. That same UE may utilize GNSS location to assist with the wireless communication with the non-terrestrial network entity, such as to perform uplink frequency and time synchronization. To obtain the GNSS location, the UE may operate in frequencies close to the L-band, such as using the Global Navigation Satellite System (GLONASS) G1 band between 1597.5 MHz and 1605.9 MHz. The proximity of these two wireless communication bands increases the likelihood of interference between them when the UE is utilizing both at once, which in-turn may lead to failed wireless communication functions over one or both wireless communication bands, such as reduced or completely lost data throughput and/or lost GNSS location, FIGS. 5 and 6, described further below, depict and describe such an example.

The aforementioned technical problem is not easily solved using conventional methods. Initially, because (as above) the wireless communication bands are regulated, it is not as easy as simply using wireless bands that are further apart and thus non-interfering for the different types of wireless communication. Further, attempting to implement filters (e.g., hardware and/or software-based radio frequency filters) between the different types of wireless communication is often technically impractical, or even infeasible, when the wireless communication bands are near to each other.

Aspects described herein overcome the technical problem and thus provide a technical solution by establishing coexistence periods in which a UE may regulate (e.g., deprioritize or disallow) certain communications over a first wireless communication band in order to prioritize communications over a second wireless communication band and thereby improve coexistence between the first and second wireless communication bands. Generally, deprioritizing a first type of communications refers to delaying or omitting entirely performance of the first type of communications in order prioritize performance of a second type of communications. Returning to the example above, a UE may deprioritize uplink transmission to a non-terrestrial network entity, such as a satellite, over the L-band in order to prioritize downlink reception of GNSS data over the G1 band. Such coexistence periods take advantage of the fact that certain types of wireless communications can be received discontinuously without significant degradation of data transfer. Generally, discontinuous reception (DRX) of wireless communications refers to the establishment of phases (e.g., time periods) in which data transfer occurs and does not occur, which allows for putting communication equipment in a lower power state more often and saving power. For example, the relatively low data rate property of GNSS signals allows for DRX of GNSS signals or receiver blanking (e.g., disabling or muting the GNSS receiver for some period of time) while maintaining sufficient positioning performance.

In some aspects described herein, a UE may therefore beneficially reduce wireless interference in a wireless communication network, such as an NTN network, by enabling a coexistence period during which transmission over a first wireless communication band is deprioritized and reception over a second wireless communication band, different from the first wireless communication is prioritized. Then the UE receives positioning data from a positioning system via the second wireless communication band during the coexistence period. The beneficial technical effect of the coexistence period is to reduce interference between the first wireless communication band and the second wireless communication band, which improves performance of the particular wireless communications tasks being performed over each (e.g., voice and data over the first wireless communication band, and positioning over the second wireless communication band.

Similarly, in other aspects described herein, a network entity may beneficially reduce wireless interference in a wireless communication network, such as an NTN network, by sending, to a UE, a configuration for a coexistence period during which transmission over a first wireless communication band is deprioritized and downlink communication over a second wireless communication band, different from the first wireless communication band, is prioritized. Here again, the beneficial technical effect of the coexistence period is to reduce interference between the first wireless communication band and the second wireless communication band, which improves performance of the wireless communication network at large.

Further aspects described herein have additional, beneficial technical effects that contribute to the solution of the technical problem of wireless interference. For example, in various aspects, a UE or a network entity may dynamically configure the coexistence period, or in some cases the UE and network entity may collaborate on the configuration, so that a coexistence period may be flexibly implemented in a wide variety of usage scenarios. The technical effect of these dynamic configuration schemes is to allow a coexistence period to be configured and utilized more often, and thereby to reduce wireless interference more often.

Thus, aspects described herein beneficially reduce wireless interference in wireless communication networks by enabling coexistence of multi-band communications between UEs and network entities.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

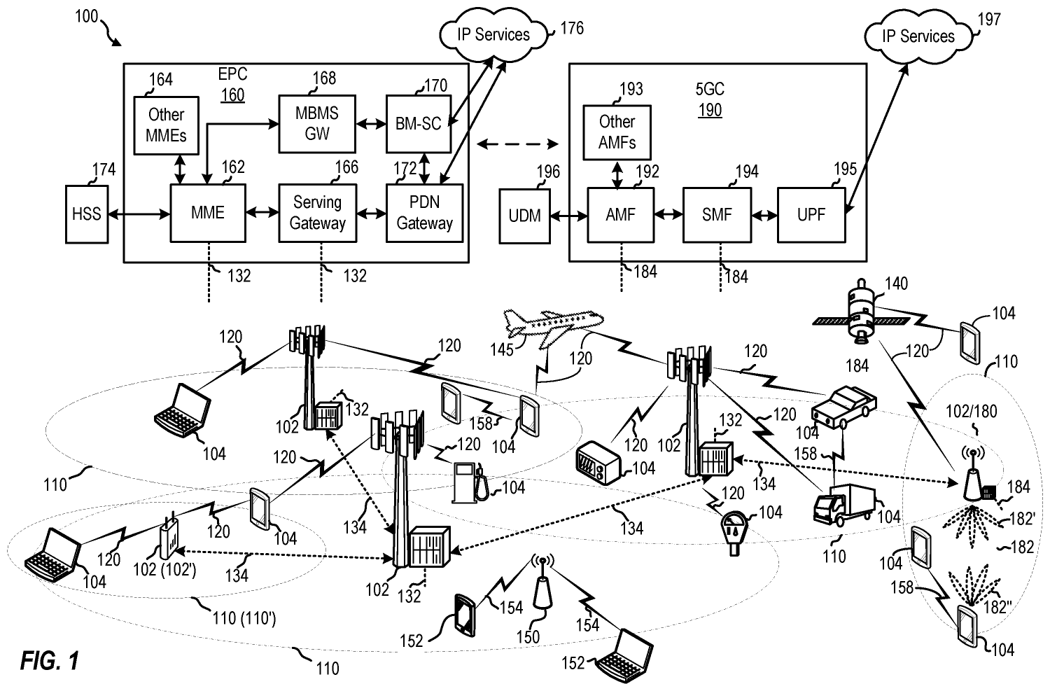

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). ABS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

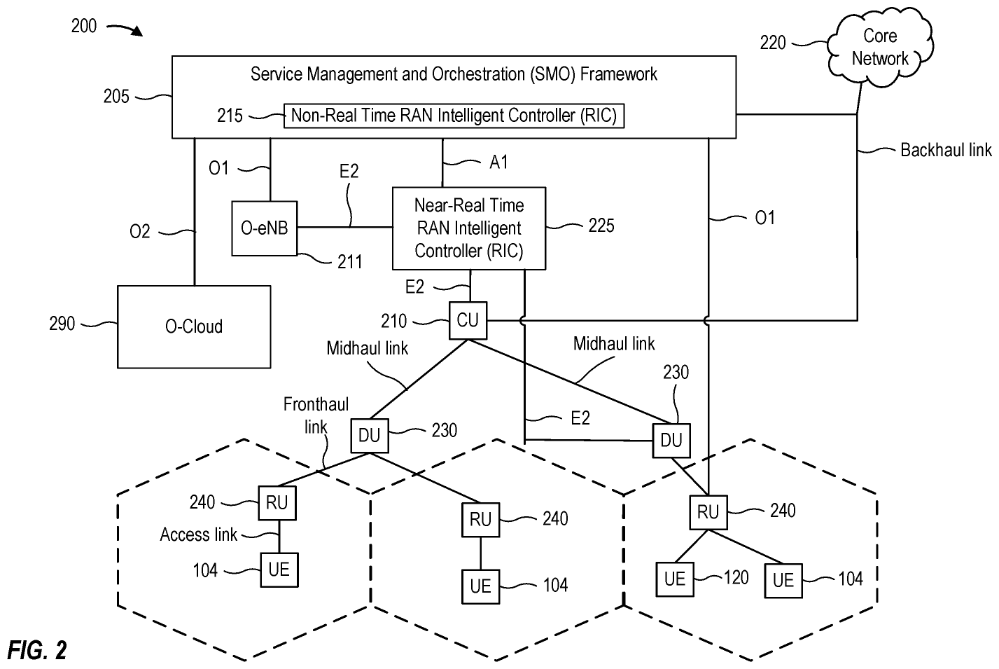

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BS s 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as Al policies).

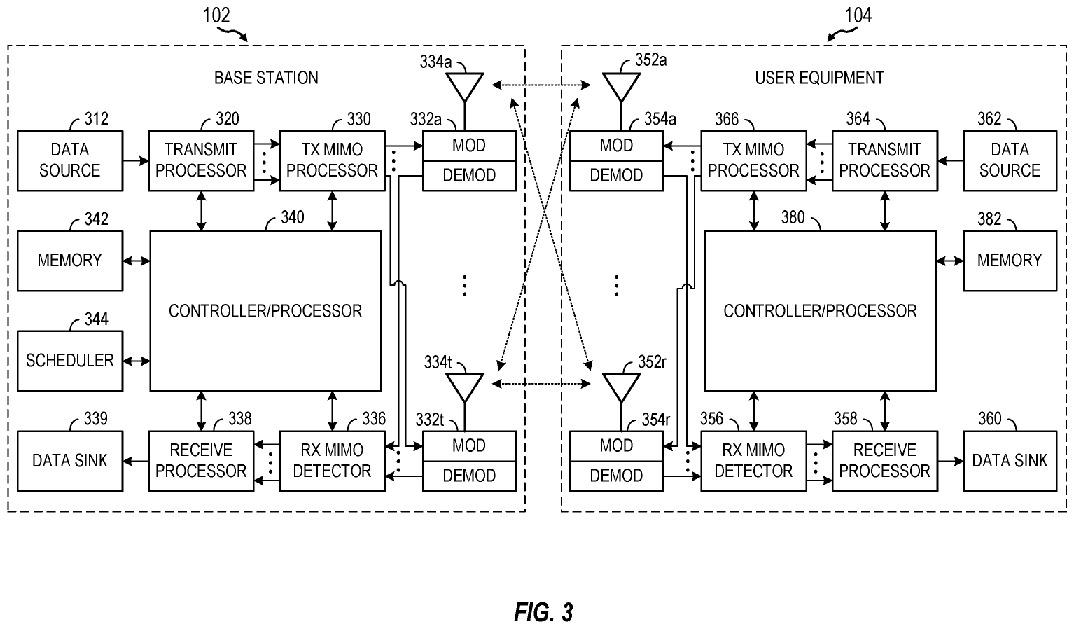

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

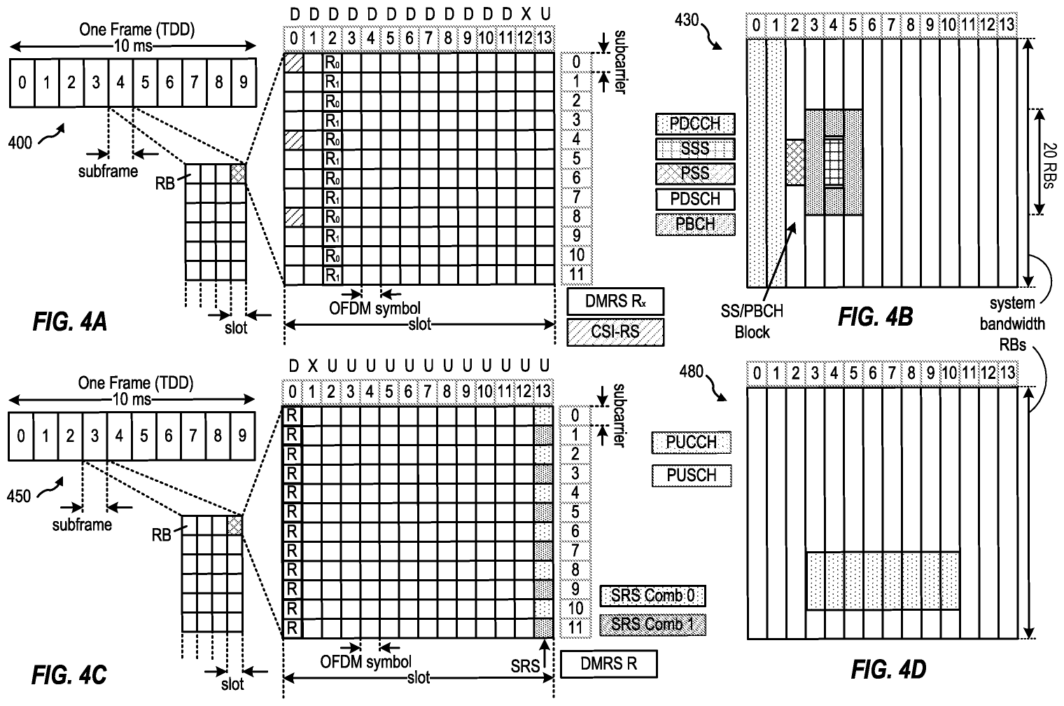

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Reducing Wireless Interference with Coexistence Periods

As briefly discussed above, aspects described herein enable coexistence of multi-band communications between UEs and network entities and beneficially reduce wireless interference in wireless communication networks.

FIG. 5 depicts an example 500 of multi-band communications in an NTN. In particular, UE 504 is communicating (e.g., voice and data) with the NTN via NTN entity 502 (a satellite in this example) and ground station 501 while also receiving GNSS data from GNSS vehicle 506.

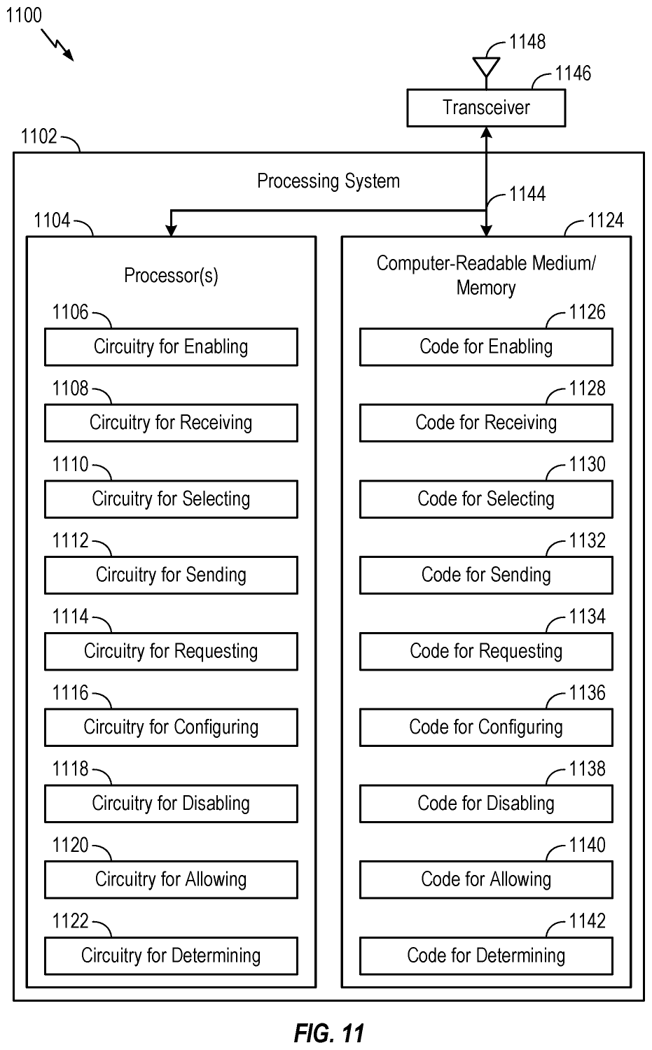

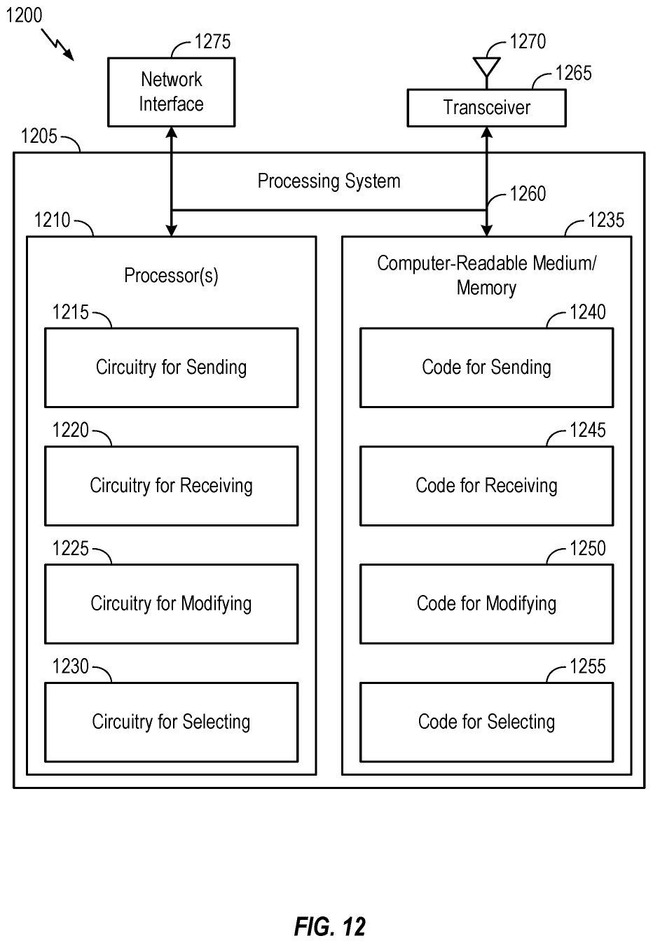

In this example, NTN entity 502 is a non-terrestrial vehicle configured to perform the function of a base station, such as BS 102 described above with respect to FIGS. 1 and 3, or the communication device 1200 described below with respect to FIG. 12. Further in this example, GNSS vehicle 506 is a satellite (a type of non-terrestrial vehicle) configured to provide geolocation signals. Further in this example, UE 504 is a UE such as UE 104 described above with respect to FIGS. 1 and 3, or the communication device 1100 described below with respect to FIG. 11.

As described above, GNSS data from GNSS vehicle 506 may assist UE 504 with performing the communications with the NTN by providing precise location of UE 504, which can be used for synchronizing time and frequency configurations for communications with non-terrestrial network entity 502.

Note that while a satellite is shown in this example as non-terrestrial network entity 502, other types of non-terrestrial network entities are equally applicable, such as aircraft, drones, balloons, and others.

FIG. 6 depicts an example 600 of various wireless communications bands that may be used in multi-band communications, including those in the NTN depicted and described with respect to FIG. 5.

In one example, a UE may communicate with an NTN over L-band 602 (with a bandwidth of 1626.5 MHz to 1660.5 MHz in this example) using an L-band duplexer. The L-band duplexer may have uplink characteristics that lead to out of band and spurious emissions. As depicted, the frequency emission range of the L-band communications, even with an L-band TX filter as depicted by line 606, results in significant interference with GNSS frequency ranges, especially the GLONASS G1 band 604, which is between 1597.5 MHz and 1605.9 MHz in this example.

For example, the out of band emission from a 20 MHz bandwidth L-band uplink transmission at 25 dBm may result in an interference power density of −92 dBm/Hz over the GLONASS G1 frequency, which is higher than a desired noise level of −185 dBm/Hz for proper GNSS signal reception. In this example, GNSS reception interruption caused by the L-band uplink transmission may severely deteriorate a UE's positioning accuracy, which in-turn degrades its uplink transmission performance.

Note that while GLONASS G1 is depicted as the primarily affected GNSS band, other GNSS bands, such as GPS and Galileo are impacted as well as indicated in FIG. 6.

As briefly described above, RF filters for a GNSS receiver (RX) and an L-band transmitter (TX) may generally not be effective at suppressing the interference between the respective bandwidths. For example, as depicted, L-band TX filter line 606 and GNSS band RX filter line 608 show overlap in each other's bandwidths, leading to the aforementioned wireless interference and loss in wireless performance.

Notably, while a UE may be able to use alternative GNSS bands having larger separation from an L-band transmitter's operating range, such as L5 GNSS bands (e.g., between 1164-1189 MHz), various network services may require the use of the adjacent bands, such as depicted in FIG. 6. For example, E911 service may only be available through L1 GNSS bands (e.g., 1559-1610 MHz) like those depicted in FIG. 6.

Aspects described herein overcome this interference by implementing coexistence periods (e.g., time periods) in which uplink transmission in an interfering band (e.g., L-band 602) are deprioritized to improve GNSS signal reception.

Generally, deprioritizing uplink transmission refers to delaying or omitting entirely the uplink transmission in order to prioritize reception of downlink signals in a given time period, such as during a coexistence period. In this example, deprioritizing L-band uplink transmission allows for prioritizing downlink GNSS signal reception. Note that while L-band and GNSS bands are used as examples herein, the coexistence periods described herein may generally be applied to any set of frequency bands (or bandwidths) that may interfere with each other.

GNSS signals may be particularly well-suited for the coexistence periods described herein due to their inherent low data rate, which makes them amenable to discontinuous reception (DRX) or receiver blanking. For example, DRX of 18 ms out of every 20 ms of continuous GPS L1 reception still produces acceptable positioning, especially when combined with other GNSS signaling, such as L5 GNSS signaling.

### Example Operations for Implementing Coexistence Periods in a Wireless Communication Network

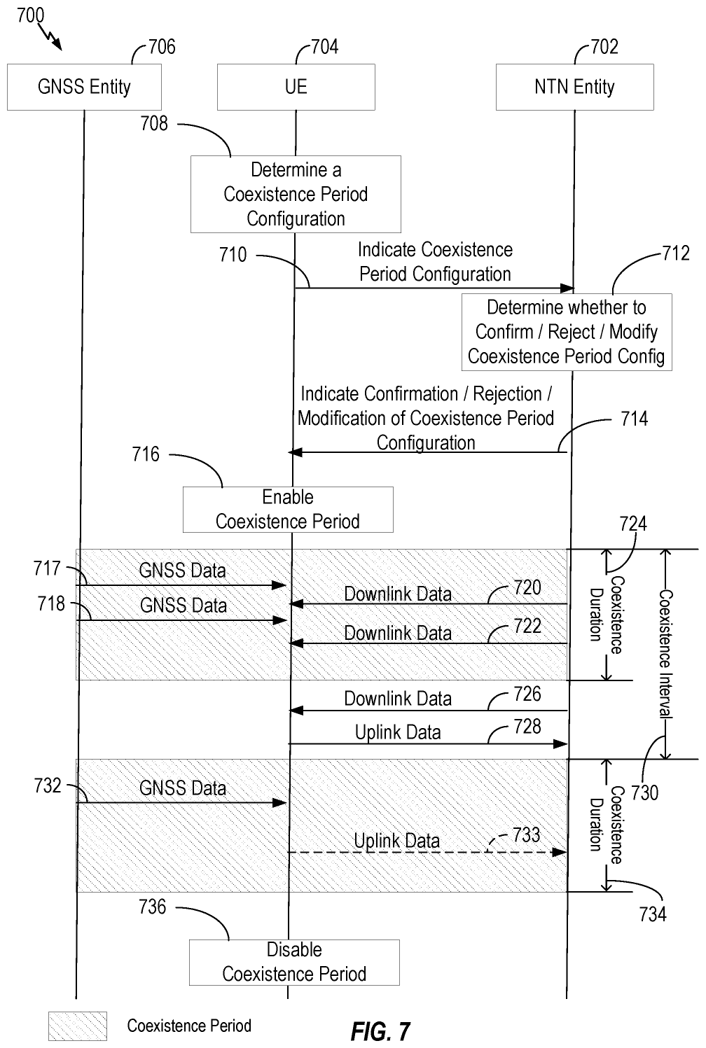

FIG. 7 depicts example operations 700 of using coexistence periods in a wireless communication network. In particular, this example includes a UE 704 configured to perform communications with NTN entity 702 and to receive data from GNSS entity 706.

In some aspects, NTN entity 702 may be a non-terrestrial vehicle configured to perform the function of a base station, such as BS 102 described above with respect to FIGS. 1 and 3, or the communication device 1200 described below with respect to FIG. 12. In some aspects, GNSS entity 706 may be a non-terrestrial vehicle configured to provide geolocation signals, such as a satellite. In some aspects, UE 704 may be a UE such as UE 104 described above with respect to FIGS. 1 and 3, or the communication device 1100 described below with respect to FIG. 11.

Operations 700 begin at operation 708 with UE 704 determining a coexistence period configuration. Generally, a coexistence period configuration may define one or more of: a start time (e.g., an absolute time, a particular frame, slot or minislot, etc.), a coexistence duration, and a coexistence interval (e.g., repetition rate or periodicity), wherein during a coexistence duration, UE 704 deprioritizes transmission over a first wireless communication band and prioritizes reception over a second wireless communication band.

In some aspects, UE 704 may be preconfigured, or configured by a network entity such as NTN entity 702, with a set of one or more coexistence periods for reducing wireless interference when utilizing multiple wireless communication bands. Thus, UE 704 may determine a coexistence period from the configured set at operation 708.

In some aspects, a coexistence period may be configured so that it is coextensive with, overlaps, or at least partially overlaps with another configured period in which UE 704 may avoid communications (e.g., uplink transmissions), such as a configured measurement period (e.g., a time period for measuring channel conditions using reference signals).

In some aspects, UE 704 may determine the coexistence period configuration based on one or more conditions. For example, UE 704 may determine the coexistence period configuration based on the availability and/or quality of GNSS signals in frequency bands that are not adjacent to the frequency band used for uplink transmission (e.g. frequency bands that are not within the adjacent channel leakage ratio (ACLR) and/or ACLR2 frequency range of the uplink transmission), and therefore not materially impacted by interference due to the uplink transmission. In other words, if UE 704 is able to derive or update its GNSS position by using a GNSS system not impacted by UE 704's uplink transmission (e.g., a GNSS system using a non-adjacent frequency band), then UE 704 may not need to configure a coexistence period. Conversely, if UE 704 is not able to derive or update its GNSS position by using a GNSS system not impacted by UE 704's uplink transmission, then UE 704 may configure a coexistence period (e.g., coexistence interval 730).

As another example, UE 704 may determine the coexistence period configuration based on the availability and/or quality of a GNSS signal in a frequency band adjacent to the frequency band used for uplink transmission, and therefore materially impacted by interference due to the uplink transmission. For example, if UE 704 determines that a GNSS signal quality is low (e.g., as measured by a signal-to-noise ratio (SNR) or another metric), then UE 704 may configure a coexistence period having a shorter interval (so that the coexistence period occurs more frequently) and/or having a longer duration in order to receive more GNSS signals without interference. Conversely, if UE 704 determines that a GNSS signal quality is high, then UE 704 may configure a coexistence period having a longer interval (so that the coexistence period occurs less frequently) and/or having a shorter duration, or no coexistence period at all.

As another example, UE 704 may determine the coexistence period configuration based on the availability and/or quality of non-terrestrial network entity data available at UE 704. For example, UE 704 may determine whether time and/or ephemeris data (e.g., data for establishing a position fix) have been decoded for a GNSS entity transmitting GNSS signals (e.g., a satellite). If such data is not available, then UE 704 may configure a coexistence period having a shorter interval and/or having a longer duration in order to receive more positioning data. Conversely, if such data is available, then UE 704 may configure a coexistence period having a longer interval and/or with a shorter duration, or no coexistence period at all.

As another example, UE 704 may determine the coexistence period configuration based on the availability (e.g., visibility) of GNSS entities (e.g., satellites) at the UE 704's current location. For example, if the UE can “see” (e.g., receive signals from) fewer than a threshold number of GNSS entities from the same or different GNSS systems, then UE 704 may configure a coexistence period having a shorter interval and/or having a longer duration in order to receive more signals from the limited set of GNSS entities and/or to try and locate additional GNSS entities. Conversely, if UE can see more than a threshold number of NTN entities from the same or different GNSS systems, then UE 704 may configure a coexistence period having a longer interval and/or having a shorter duration, or no coexistence period at all.

As another example, UE 704 may determine the coexistence period configuration based on mobility information. For example, if UE 704 is moving quickly (e.g., a vehicle moving faster than 60 MPH), then UE 704 may configure a coexistence period having shorter interval and/or having a longer duration in order to allow UE 704 to update its location more often. Conversely, if UE is moving slowly or stationary, then UE 704 may configure a coexistence period having a longer interval and/or having a shorter duration, or no coexistence period at all. Note that more generally there is a tradeoff between speed and the coexistence interval and duration, wherein the higher the speed, generally the shorter the interval and longer the duration and vice versa.

As another example, UE 704 may determine the coexistence period configuration based on data integrity checks to ensure authentic signals and even authentication as in the case of Open Service Navigation Message Authentication (OSNMA). For example, if UE 704 determines that data integrity checks have failed or authentication has failed, then UE 704 may configure a coexistence period having a shorter interval and/or having a longer duration to attempt further integrity checks and/or authorization attempts. Conversely, if UE determines data integrity checks have succeeded or authentication has succeeded, then UE 704 may configure a coexistence period having a longer interval and/or having a shorter duration, or no coexistence period at all.

As another example, UE 704 may determine the coexistence period configuration based on an emergency call state. For example, if UE 704 is making an emergency call, then UE 704 may configure a coexistence period that is shorter (e.g., more frequent) and/or with a longer duration. Conversely, if UE is not making an emergency call, then UE 704 may configure a coexistence period that is longer (e.g., less frequent) and/or with a shorter duration, or no coexistence period at all.

Operations 700 then proceed to operation 710 with UE 704 sending an indication of the coexistence period configuration to NTN entity 702. The indication may generally include one or more of the start time, interval, and duration of a coexistence period. Generally, the indication can be sent in various types of signaling, including one or more of L1, L2, and/or L3 signaling to send the indications. For example, UE 704 may send a physical layer signal, an RRC message, and/or a MAC control element to indicate a coexistence period.

Operations 700 then proceed to operation 712 with NTN entity 702 determining whether to confirm, reject, or modify the coexistence period configuration indicated in operation 710.

For example, NTN entity 702 may consider UE 704's real-time traffic and its QoS requirement to make its determination. For example, if NTN entity 702 schedules UE 704 for periodic uplink transmissions with low latency requirement, then NTN entity 702 may adjust the coexistence period configuration such that it overlaps with the scheduled uplink transmissions as least as possible.

Operations 700 then proceed to operation 714 with NTN entity 702 sending a message to UE 704 confirming, rejecting, or modifying the coexistence period configuration. For example, when modifying the coexistence period configuration, NTN entity 702 may lengthen or shorten the coexistence interval and/or its duration.

Operations 700 then proceed to operation 716 with UE 704 enabling a coexistence period according to either the originally indicated coexistence period configuration indicated at operation 710, or the modified coexistence period configuration included in NTN entity 702's response at operation 714. Enabling the coexistence period may generally be done by setting a software setting, flag, parameter, or the like.

As depicted in FIG. 7, the coexistence period configuration includes a coexistence interval 730 between (e.g., a periodicity of) the initiation of each coexistence duration as well as a time (e.g., 724 and 734) of each coexistence duration in which UE 704 deprioritizes transmission over a first wireless communication band (e.g., on a band supporting communication between UE 704 and NTN entity 702, such as an L-band) and prioritizes reception over a second wireless communication band (e.g., on a band supporting reception of GNSS data from GNSS entity 706).

Accordingly, after enabling the coexistence period, UE 704 prioritizes receiving GNSS data at 717 and 718 during a first coexistence duration 724 and then again prioritizes receiving GNSS data at operation 732 during a second coexistence duration 734. The GNSS data received by UE 704 during the coexistence durations 724 and 734 may be used by UE 704 for determining its position, which in-turn can be used for other tasks.

Note that during a coexistence duration, UE 704 can still receive downlink data from the network, such as from NTN entity 702 because the downlink data tends to be of lower signal strength at reception and therefore creates less interference with the reception of GNSS data signals at operations 717 and 718 in this example. This is depicted during coexistence duration 724 when downlink data 720 and 722 is also received. However, this need not be the case. As depicted during coexistence duration 734, no downlink data is sent by NTN entity 702 (and therefore no downlink data is received by UE 704).

Beneficially, coexistence duration 724 has the technical effect of reducing interference with UE 704's reception of GNSS data from GNSS entity 706 while still enabling UE 704 to receive downlink data from NTN entity 702.

Operations 700 then proceed to operations 726 and 728 with UE 704 receiving downlink data at operation 726 and sending uplink data at 728, as in normal network operations. Note that operations 726 and 728 take place while the coexistence period is enabled, but outside of the coexistence duration within each period (e.g., not within coexistence duration 724 or 734).

Operations 700 then proceed to operation 732 with UE 704 receiving GNSS data during a second coexistence duration during a second coexistence period.

In some aspects, UE 704 may be configured with a rule, function, or a priority associated with certain types of data that causes UE 704 to override the configured coexistence period during any particular duration, without actually disabling the coexistence period. In the typical case, uplink data that can tolerate an increased latency and/or packet loss may be deprioritized according to the coexistence period configuration and delayed until later for transmission, such as delayed during coexistence duration 724 and then sent in an uplink transmission at operation 728 outside of the coexistence duration 724. However, when scheduled uplink data meets a specific criteria, triggers a rule, or is otherwise associated with a high enough priority, it may override the coexistence period configuration and be sent during a coexistence duration, such as depicted at operation 733 during coexistence duration 734.

Operations 700 then proceed to operation 736 with UE 704 disabling the coexistence period. Disabling the coexistence period may be performed according to the coexistence period configuration (e.g., after a set amount of time, or coexistence periods have elapsed), or based on conditions. For example, where UE 704 does not need precise location data, it may disable the coexistence period.

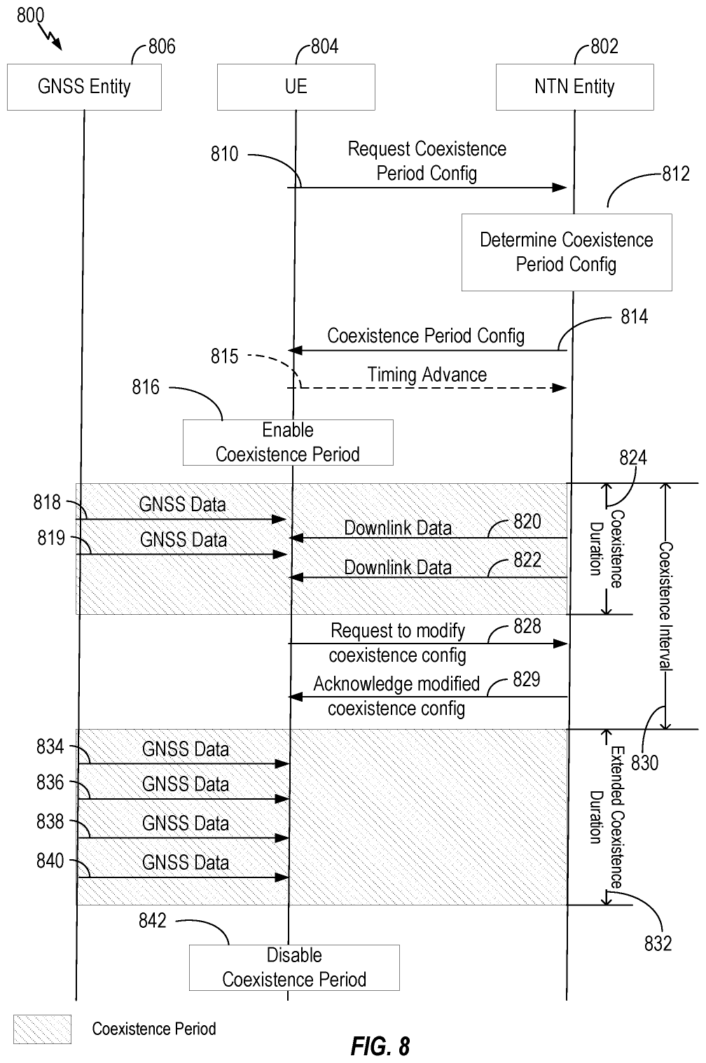

FIG. 8 depicts example operations 800 of using coexistence periods in a wireless communication network. In particular, this example includes a UE 804 configured to perform communications with NTN entity 802 and to receive data from GNSS entity 806.

In some aspects, NTN entity 802 may be a non-terrestrial vehicle configured to perform the function of a base station, such as BS 102 described above with respect to FIGS. 1 and 3, or the communication device 1200 described below with respect to FIG. 12. In some aspects, GNSS entity 806 may be a non-terrestrial vehicle configured to provide geolocation signals, such as a satellite. In some aspects, UE 804 may be a UE such as UE 104 described above with respect to FIGS. 1 and 3, or the communication device 1100 described below with respect to FIG. 11.

Operations 800 begin at operation 810 with UE 804 requesting a coexistence period configuration from NTN entity 802.

Operations 800 then proceed to operation 812 with NTN entity 802 determining a coexistence period configuration indicated for UE 804.

As above, NTN entity 802 may consider UE 804′s real-time traffic and its QoS requirement to configure a coexistence period. Further, NTN entity 802 may determine a configuration based on one or more of the considerations discussed above with respect to operation 708 in FIG. 7. For example, UE 804 may send information regarding its state, the state of GNSS systems it is utilizing, and the like to NTN entity 802 with its request at operation 810 or separately (not depicted).

Operations 800 then proceed to operation 814 with NTN entity 802 sending a coexistence period configuration to UE 804. In some aspects, the coexistence period configuration may be a simple index or other indication that enables UE 804 to choose from a set of preconfigured coexistence periods stored on UE 804. For example, the set of preconfigured coexistence periods may have been configured by NTN entity 802, or another network entity, prior to operations 800.

In some aspects, operations 800 proceed to operation 815 with UE 804 reporting information to NTN entity 802 to assist NTN entity 802 determining which uplink (sub)frames are within a coexistence duration. For example, UE 804 may report its uplink timing advance (TA) information to NTN entity 702 at operation 815. Generally, TA information is used to control the uplink transmission timing of an individual UE and helps to ensure that uplink transmissions from all UE are synchronized when received by the base station. In some aspects, such information may be reported with the request for a coexistence period at operation 810.

Operations 800 then proceed to operation 816 with UE 804 enabling a coexistence period according to the coexistence period configuration received from NTN entity 802 at operation 814. As above, enabling the coexistence period may generally be done by software setting, flag, parameter, or the like.

As depicted with the example in FIG. 7, here the coexistence period configuration includes a coexistence interval 830 between (e.g., a periodicity of) the initiation of each coexistence duration as well as a time (e.g., 824) of each coexistence duration in which UE 804 deprioritizes transmission over a first wireless communication band (e.g., on a band supporting communication between UE 804 and NTN entity 802, such as an L-band) and prioritizes reception over a second wireless communication band (e.g., on a band supporting reception of GNSS data from GNSS entity 806).

Accordingly, after enabling the coexistence period, UE 804 prioritizes receiving GNSS data at operations 818 and 819 during a first coexistence duration 824 and then again prioritizes receiving GNSS data at operations 834, 836, 838, and 840 during a second coexistence duration 832.

As above, during coexistence duration 824, UE 804 still receives downlink data from NTN entity 802 at operations 820 and 822. Though, as above, this need not be the case. As depicted during coexistence duration 832, no downlink data is received by UE 804 from NTN entity 802.

Beneficially, coexistence duration 824 during coexistence period 830 has the technical effect of reducing interference with UE 804's reception of GNSS data from GNSS entity 806 while still enabling UE 804 to receive downlink data from NTN entity 802.

Operations 800 then proceed to operation 828 with UE 804 requesting a modified coexistence configuration. Specifically, in this example, UE 804 determines that the existing coexistence duration 824 is not enough for UE 804 to achieve an acceptable GNSS signal reception level, and thus requests at operation 828 an extended coexistence duration.

Operations 800 then proceed to operation 829 with NTN entity 802 acknowledging the modified coexistence configuration. Alternatively, as in operation 714 described above with respect to FIG. 7, NTN entity 802 could reject or further modify the coexistence configuration based on the request received at operation 828.

Operations 800 then proceed to operations 834, 836, 838, and 840 in which UE 804 receives GNSS data during an extended coexistence duration 832.

Operations 800 then proceed to operation 842 with UE 804 disabling the coexistence period. As above, disabling the coexistence period may be performed according to the coexistence period configuration (e.g., after a set amount of time, or coexistence periods have elapsed), or based on conditions.

### HARQ Process During Coexistence Periods

As depicted and described above with respect to FIGS. 7 and 8, a UE may still receive downlink communications during a coexistence duration within a coexistence period. For example, as described above, a UE may still receive downlink network communications while also receiving data from a GNSS system because the downlink communications may not cause the same level of interference as uplink communications sent from the UE.

In some aspects, a UE such as UE 704 and 804 above may be configured to switch a downlink hybrid automatic repeat request (HARQ) process from HARQ feedback-enabled mode to HARQ feedback-disabled mode during the coexistence duration, which allows the UE to keep receiving downlink data while not sending the corresponding HARQ feedback on the uplink during a coexistence duration.

Further, a UE may be configured to switch the DL HARQ process back to HARQ feedback-enabled mode after a coexistence duration (e.g., after coexistence durations 724 and 824 described above with respect to FIGS. 7 and 8), or alternatively after the coexistence period configuration is released or disabled (e.g., after operations 736 and 842 described above with respect to FIGS. 7 and 8).

### Example Operations of a User Equipment

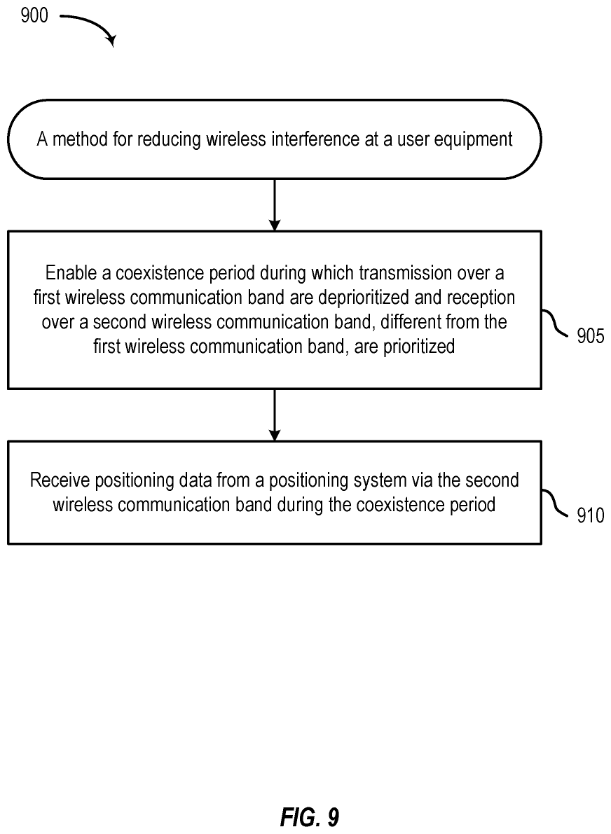

FIG. 9 shows a method 900 for reducing wireless interference at a user equipment, such as UE 104 of FIGS. 1 and 3.

Method 900 begins at step 905 with enabling a coexistence period during which transmission over a first wireless communication band is deprioritized and reception over a second wireless communication band, different from the first wireless communication band, is prioritized.

Method 900 then proceeds to step 910 with receiving positioning data from a positioning system via the second wireless communication band during the coexistence period.

In one aspect, method 900 further includes selecting a configuration for the coexistence period.

In one aspect, method 900 further includes sending, to a network, the configuration for the coexistence period.

In one aspect, method 900 further includes receiving, from the network, a confirmation of the configuration for the coexistence period.

In one aspect, method 900 further includes receiving, from the network, a modified configuration for the coexistence period, wherein enabling the coexistence period is according to the modified configuration for the coexistence period.

In one aspect, selecting the configuration for the coexistence period comprises selecting the configuration from a plurality of pre-configured configurations.

In one aspect, selecting the configuration from a plurality of pre-configured configurations is based at least in part on the configuration at least partially overlapping with a configured measurement period.

In one aspect, selecting the configuration for the coexistence period comprises considering one or more of: an availability of the positioning data from the positioning system, or another positioning system, via a third wireless communication band, different from the first wireless communication band and the second wireless communication band; a quality of a signal bearing the positioning data received via the second wireless communication band; an availability of location data for a mobile entity of the positioning system; mobility information regarding the user equipment; location information regarding the user equipment; an authentication status associated with the positioning system; or an operational state of the user equipment.

In one aspect, selecting the configuration for the coexistence period comprises considering an availability of ephemeris data for a satellite vehicle of the positioning system.

In one aspect, method 900 further includes requesting, from a network, a configuration for the coexistence period.

In one aspect, method 900 further includes receiving, from the network, the configuration for the coexistence period.

In one aspect, method 900 further includes configuring the coexistence period based on the configuration for the coexistence period.

In one aspect, method 900 further includes receiving data from a network via the first wireless communication band during the coexistence period.

In one aspect, method 900 further includes disabling hybrid automatic repeat request feedback during the coexistence period.

In one aspect, method 900 further includes allowing hybrid automatic repeat request feedback outside of the coexistence period.

In one aspect, method 900 further includes disabling the coexistence period.

In one aspect, method 900 further includes allowing hybrid automatic repeat request feedback after disabling the coexistence period.

In one aspect, method 900 further includes sending, to a network, an indication to enable or disable the coexistence period via at least one of a MAC-CE or a physical layer signal.

In one aspect, method 900 further includes sending, to the network, timing information related to the transmission over the first wireless communication band.

In one aspect, method 900 further includes determining data for sending to a network has a sending priority higher than a threshold.

In one aspect, method 900 further includes sending the data to the network via the first wireless communication band during the coexistence period.

In one aspect, method 900 further includes enabling the coexistence period based at least in part on the first wireless communication band having less than a threshold frequency band gap from the second wireless communication band.

In one aspect, the coexistence period is defined by one or more of: a periodicity of the coexistence period; a time offset of the coexistence period; or a duration of the coexistence period.

In one aspect, the first wireless communication band is an L band, and the second wireless communication band is a GNSS communication band.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a Network Entity

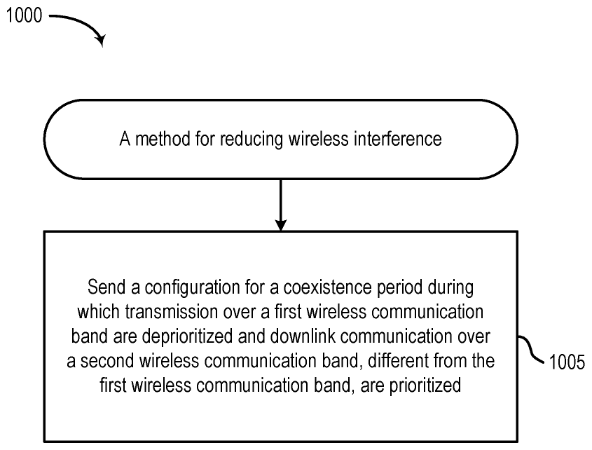

FIG. 10 shows a method 1000 for reducing wireless interference at a wireless node, such as BS 102 of FIGS. 1 and 3, or a disaggregated base station as discussed with respect to FIG. 2.

Method 1000 begins at 1005 with sending, to a user equipment, a configuration for a coexistence period during which transmission over a first wireless communication band is deprioritized and downlink communication over a second wireless communication band, different from the first wireless communication band, is prioritized.

In one aspect, method 1000 further includes sending, to the user equipment, during the coexistence period, downlink communication over the first wireless communication band.

In one aspect, method 1000 further includes receiving, from the user equipment, a requested configuration for the coexistence period.

In one aspect, method 1000 further includes modifying the requested configuration for the coexistence period to generate the configuration for the coexistence period sent to the user equipment.

In one aspect, the configuration for the coexistence period comprises an indication configured to be used by the user equipment for selecting the configuration from a plurality of pre-configured configurations.

In one aspect, method 1000 further includes selecting the configuration for the coexistence period based at least in part on the configuration for the coexistence period at least partially overlapping with a configured measurement period for the user equipment.

In one aspect, the mobile entity of the positioning system comprises a satellite vehicle, and the location data for the mobile entity of the positioning system comprises ephemeris data.

In one aspect, method 1000 further includes selecting the configuration for the coexistence period based on one or more of: network traffic associated with the user equipment; a QoS requirement associated with the user equipment; an availability of positioning data from a positioning system; a quality of a signal bearing positioning data received by the user equipment; an availability of location data for a mobile entity of a positioning system; mobility information regarding the user equipment; location information regarding the user equipment; an authentication status associated with a positioning system; or an operational state of the user equipment.

In one aspect, method 1000 further includes receiving hybrid automatic repeat request feedback regarding the downlink communication sent over the first wireless communication band after the coexistence period.

In one aspect, method 1000 further includes receiving, from the user equipment, timing information related to a transmission from the user equipment over a first wireless communication band.

In one aspect, method 1000 further includes receiving, from the user equipment, an indication to enable or disable the coexistence period via a MAC-CE or a physical layer signal.

In one aspect, method 1000 further includes sending, to the user equipment, a function for determining when data for sending to a network has a sending priority higher than a threshold.

In one aspect, the coexistence period is defined by one or more of: a periodicity of the coexistence period; a time offset of the coexistence period; or a duration of the coexistence period.

In one aspect, the first wireless communication band is an L band, and the second wireless communication band is a GNSS communication band.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1102 coupled to a transceiver 1146 (e.g., a transmitter and/or a receiver). The transceiver 1146 is configured to transmit and receive signals for the communications device 1100 via an antenna 1148, such as the various signals as described herein. The processing system 1102 may be configured to perform processing functions for the communications device 1100, including processing signals received and/or to be transmitted by the communications device 1100.

The processing system 1102 includes one or more processors 1104. In various aspects, the one or more processors 1104 may be representative of one or more of receive processor 358, transmit processor 364, TX MIMO processor 366, and/or controller/processor 380, as described with respect to FIG. 3. The one or more processors 1104 are coupled to a computer-readable medium/memory 1124 via a bus 1144. In certain aspects, the computer-readable medium/memory 1124 is configured to store instructions (e.g., computer-executable code), including code aspects 1126-1142, that when executed by the one or more processors 1104, enable and cause the one or more processors 1104 to perform operations performed by the UE as described with respect to FIGS. 7 and 8 as well as the method 900 described with respect to FIG. 9, or any aspect related to it, including any additional steps or sub-steps described in relation to FIG. 9. Note that reference to a processor performing a function of communications device 1100 may include one or more processors performing that function of communications device 1100.

In the depicted example, computer-readable medium/memory 1124 stores code for enabling 1126, code for receiving 1128, code for selecting 1130, code for sending 1132, code for requesting 1134, code for configuring 1136, code for disabling 1138, code for allowing 1140, and code for determining 1142. Processing of code 1126-1142 may enable and cause the communications device 1100 to perform the method 900 described with respect to FIG. 9, or any aspect related to it.

The one or more processors 1104 include circuitry configured to implement (e.g., execute) the code stored in the computer-readable medium/memory 1124, including circuitry for enabling 1106, circuitry for receiving 1108, circuitry for selecting 1110, circuitry for sending 1112, circuitry for requesting 1114, circuitry for configuring 1116, circuitry for disabling 1118, circuitry for allowing 1120, and circuitry for determining 1122. Processing with circuitry 1106-1122 may enable and cause the communications device 1100 to perform the method 900 described with respect to FIG. 9, or any aspect related to it.

Various components of the communications device 1100 may provide means for performing operations performed by the UE as described with respect to FIGS. 7 and 8 as well as the method 900 described with respect to FIG. 9, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1146 and/or antenna 1148 of the communications device 1100 in FIG. 11, and/or one or more processors 1104 of the communications device 1100 in FIG. 11. Means for communicating, receiving or obtaining may include the transceivers 354, antenna(s) 352, receive processor 358, and/or controller/processor 380 of the UE 104 illustrated in FIG. 3, transceiver 1146 and/or antenna 1148 of the communications device 1100 in FIG. 11, and/or one or more processors 1104 of the communications device 1100 in FIG. 11.

FIG. 12 depicts aspects of an example communications device. In some aspects, communications device 1200 is a network entity, such as BS 102 of FIGS. 1 and 3, or a disaggregated base station as discussed with respect to FIG. 2.

The communications device 1200 includes a processing system 1205 coupled to a transceiver 1265 (e.g., a transmitter and/or a receiver) and/or a network interface 1275. The transceiver 1265 is configured to transmit and receive signals for the communications device 1200 via an antenna 1270, such as the various signals as described herein. The network interface 1275 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1235 via a bus 1260. In certain aspects, the computer-readable medium/memory 1235 is configured to store instructions (e.g., computer-executable code), including code aspects 1240-1245, that when executed by the one or more processors 1210, enable and cause the one or more processors 1210 to perform operations performed by the network entity as described with respect to FIGS. 7 and 8 as well as the method 1000 described with respect to FIG. 10, or any aspect related to it, including any additional steps or sub-steps described in relation to FIG. 10. Note that reference to a processor of communications device 1200 performing a function may include one or more processors of communications device 1200 performing that function.

In the depicted example, the computer-readable medium/memory 1235 stores code for sending 1240, code for receiving 1245, code for modifying 1250, and code for selecting 1255. Processing of code 1240-1255 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1235, including circuitry for sending 1215, circuitry for receiving 1220, circuitry for modifying 1225, and circuitry for selecting 1230. Processing with circuitry 1215-1230 may enable and cause the communications device 1200 to perform the method 1000 described with respect to FIG. 10, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1265 and/or antenna 1270 of the communications device 1200 in FIG. 12, and/or one or more processors 1210 of the communications device 1200 in FIG. 12. Means for communicating, receiving or obtaining may include the transceivers 332, antenna(s) 334, receive processor 338, and/or controller/processor 340 of the BS 102 illustrated in FIG. 3, transceiver 1265 and/or antenna 1270 of the communications device 1200 in FIG. 12, and/or one or more processors 1210 of the communications device 1200 in FIG. 12.

### EXAMPLE CLAUSES

Implementation examples are described in the following numbered clauses:

Clause 1: A method for reducing wireless interference at a user equipment, comprising: enabling a coexistence period during which transmission over a first wireless communication band is deprioritized and reception over a second wireless communication band, different from the first wireless communication band, is prioritized; and receiving positioning data from a positioning system via the second wireless communication band during the coexistence period.

Clause 2: The method of claim 1, further comprising: selecting a configuration for the coexistence period; and sending, to a network, the configuration for the coexistence period.

Clause 3: The method of claim 2, further comprising receiving, from the network, a confirmation of the configuration for the coexistence period.

Clause 4: The method of claim 2, further comprising: receiving, from the network, a modified configuration for the coexistence period, wherein enabling the coexistence period is according to the modified configuration for the coexistence period.

Clause 5: The method of claim 2, wherein selecting the configuration for the coexistence period comprises selecting the configuration from a plurality of pre-configured configurations.

Clause 6: The method of claim 5, wherein selecting the configuration from a plurality of pre-configured configurations is based at least in part on the configuration at least partially overlapping with a configured measurement period.

Clause 7: The method of claim 2, wherein selecting the configuration for the coexistence period comprises considering one or more of: an availability of the positioning data from the positioning system, or another positioning system, via a third wireless communication band, different from the first wireless communication band and the second wireless communication band; a quality of a signal bearing the positioning data received via the second wireless communication band; an availability of location data for a mobile entity of the positioning system; mobility information regarding the user equipment; location information regarding the user equipment; an authentication status associated with the positioning system; or an operational state of the user equipment.

Clause 8: The method of claim 2, wherein selecting the configuration for the coexistence period comprises considering an availability of ephemeris data for a satellite vehicle of the positioning system.

Clause 9: The method of claim 1, further comprising: requesting, from a network, a configuration for the coexistence period; receiving, from the network, the configuration for the coexistence period; and configuring the coexistence period based on the configuration for the coexistence period.

Clause 10: The method of claim 1, further comprising receiving data from a network via the first wireless communication band during the coexistence period.

Clause 11: The method of claim 10, further comprising disabling hybrid automatic repeat request feedback during the coexistence period.

Clause 12: The method of claim 11, further comprising allowing hybrid automatic repeat request feedback outside of the coexistence period.

Clause 13: The method of claim 11, further comprising: disabling the coexistence period; and allowing hybrid automatic repeat request feedback after disabling the coexistence period.

Clause 14: The method of claim 1, further comprising sending, to a network, an indication to enable or disable the coexistence period via at least one of a MAC-CE or a physical layer signal.

Clause 15: The method of claim 1, further comprising sending, to the network, timing information related to the transmission over the first wireless communication band.

Clause 16: The method of claim 1, further comprising: determining data for sending to a network has a sending priority higher than a threshold; and sending the data to the network via the first wireless communication band during the coexistence period.

Clause 17: The method of claim 1, further comprising enabling the coexistence period based at least in part on the first wireless communication band having less than a threshold frequency band gap from the second wireless communication band.

Clause 18: The method of claim 1, wherein the coexistence period is defined by one or more of: a periodicity of the coexistence period; a time offset of the coexistence period; or a duration of the coexistence period.

Clause 19: The method of claim 1, wherein: the first wireless communication band is an L band, and the second wireless communication band is a GNSS communication band.

Clause 20: A method for reducing wireless interference, comprising: sending, to a user equipment, a configuration for a coexistence period during which transmission over a first wireless communication band is deprioritized and downlink communication over a second wireless communication band, different from the first wireless communication band, is prioritized.

Clause 21: The method of claim 20, further comprising: sending, to the user equipment, during the coexistence period, downlink communication over the first wireless communication band.

Clause 22: The method of claim 20, further comprising receiving, from the user equipment, a requested configuration for the coexistence period.

Clause 23: The method of claim 22, further comprising modifying the requested configuration for the coexistence period to generate the configuration for the coexistence period sent to the user equipment.

Clause 24: The method of claim 20, wherein the configuration for the coexistence period comprises an indication configured to be used by the user equipment for selecting the configuration from a plurality of pre-configured configurations.

Clause 25: The method of claim 20, further comprising selecting the configuration for the coexistence period based at least in part on the configuration for the coexistence period at least partially overlapping with a configured measurement period for the user equipment.

Clause 27: The method of claim 25, wherein: the mobile entity of the positioning system comprises a satellite vehicle, and the location data for the mobile entity of the positioning system comprises ephemeris data.

Clause 26: The method of claim 20, further comprising selecting the configuration for the coexistence period based on one or more of: network traffic associated with the user equipment; a QoS requirement associated with the user equipment; an availability of positioning data from a positioning system; a quality of a signal bearing positioning data received by the user equipment; an availability of location data for a mobile entity of a positioning system; mobility information regarding the user equipment; location information regarding the user equipment; an authentication status associated with a positioning system; or an operational state of the user equipment.

Clause 28: The method of claim 20, further comprising receiving hybrid automatic repeat request feedback regarding the downlink communication sent over the first wireless communication band after the coexistence period.

Clause 30: The method of claim 28, further comprising receiving, from the user equipment, timing information related to a transmission from the user equipment over a first wireless communication band.

Clause 29: The method of claim 20, further comprising receiving, from the user equipment, an indication to enable or disable the coexistence period via a MAC-CE or a physical layer signal.

Clause 31: The method of claim 20, further comprising sending, to the user equipment, a function for determining when data for sending to a network has a sending priority higher than a threshold.

Clause 32: The method of claim 20, wherein the coexistence period is defined by one or more of: a periodicity of the coexistence period; a time offset of the coexistence period; or a duration of the coexistence period.

Clause 33: The method of claim 20, wherein: the first wireless communication band is an L band, and the second wireless communication band is a GNSS communication band.

Clause 34: An apparatus, comprising: a memory comprising executable instructions; and a processor configured to execute the executable instructions and cause the apparatus to perform a method in accordance with any one of Clauses 1-33.

Clause 35: An apparatus, comprising means for performing a method in accordance with any one of Clauses 1-33.

Clause 36: A non-transitory computer-readable medium comprising executable instructions that, when executed by a processor of an apparatus, cause the apparatus to perform a method in accordance with any one of Clauses 1-33.

Clause 37: A computer program product embodied on a computer-readable storage medium comprising code for performing a method in accordance with any one of Clauses 1-33.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment configured for wireless communications, comprising: a memory comprising processor-executable instructions; and a processor configured to execute the processor-executable instructions and cause the user equipment to:
enable a coexistence period during which transmission over a first wireless communication band is deprioritized and reception over a second wireless communication band, different from the first wireless communication band, is prioritized; and
receive positioning data from a positioning system via the second wireless communication band during the coexistence period.

2. The user equipment of claim 1, wherein the processor is further configured to cause the user equipment to:
select a configuration for the coexistence period; and
send, to a network, the configuration for the coexistence period.

3. The user equipment of claim 2, wherein the processor is further configured to cause the user equipment to receive, from the network, a confirmation of the configuration for the coexistence period.

4. The user equipment of claim 2, wherein the processor is further configured to cause the user equipment to:
receive, from the network, a modified configuration for the coexistence period, and
enable the coexistence period according to the modified configuration for the coexistence period.

5. The user equipment of claim 2, wherein in order to select the configuration for the coexistence period, the processor is further configured to cause the user equipment to select the configuration from a plurality of pre-configured configurations.

6. The user equipment of claim 5, wherein the processor is further configured to cause the user equipment to select the configuration from the plurality of pre-configured configurations based at least in part on the configuration at least partially overlapping with a configured measurement period.

7. The user equipment of claim 2, wherein the processor is further configured to cause the user equipment to select the configuration for the coexistence period based on one or more of:
an availability of the positioning data from the positioning system, or another positioning system, via a third wireless communication band, different from the first wireless communication band and the second wireless communication band;
a quality of a signal bearing the positioning data received via the second wireless communication band;
an availability of location data for a mobile entity of the positioning system;
mobility information regarding the user equipment;
location information regarding the user equipment;
an authentication status associated with the positioning system; or
an operational state of the user equipment.

8. The user equipment of claim 2, wherein in order to select the configuration for the coexistence period, the processor is further configured to cause the user equipment to determine an availability of ephemeris data for a satellite vehicle of the positioning system.

9. The user equipment of claim 1, wherein the processor is further configured to cause the user equipment to:
request, from a network, a configuration for the coexistence period; and
receive, from the network, the configuration for the coexistence period; and
configure the coexistence period based on the configuration for the coexistence period.

10. The user equipment of claim 1, wherein the processor is further configured to cause the user equipment to receive data from a network via the first wireless communication band during the coexistence period.

11. The user equipment of claim 10, wherein the processor is further configured to cause the user equipment to disable hybrid automatic repeat request feedback during the coexistence period.

12. The user equipment of claim 11, wherein the processor is further configured to cause the user equipment to allow hybrid automatic repeat request feedback outside of the coexistence period.

13. The user equipment of claim 11, wherein the processor is further configured to cause the user equipment to:
disable the coexistence period; and
allow hybrid automatic repeat request feedback after disabling the coexistence period.

14. The user equipment of claim 1, wherein the processor is further configured to cause the user equipment to send, to a network, an indication to enable or disable the coexistence period via at least one of a medium access control control element (MAC-CE) or a physical layer signal.

15. The user equipment of claim 1, wherein the processor is further configured to cause the user equipment to send, to a network, timing information related to the transmission over the first wireless communication band.

16. The user equipment of claim 1, wherein the processor is further configured to cause the user equipment to:
determine data for sending to a network has a sending priority higher than a threshold; and
send the data to the network via the first wireless communication band during the coexistence period.

17. The user equipment of claim 1, wherein the processor is further configured to cause the user equipment to enable the coexistence period based at least in part on the first wireless communication band having less than a threshold frequency band gap from the second wireless communication band.

18. The user equipment of claim 1, wherein the coexistence period is defined by one or more of:
a periodicity of the coexistence period;
a time offset of the coexistence period; or
a duration of the coexistence period.

19. The user equipment of claim 1, wherein:
the first wireless communication band is an L band, and
the second wireless communication band is a global navigation satellite system (GNSS) communication band.

20. A method for reducing wireless interference at a user equipment, comprising:
enabling a coexistence period during which transmission over a first wireless communication band is deprioritized and reception over a second wireless communication band, different from the first wireless communication band, is prioritized; and
receiving positioning data from a positioning system via the second wireless communication band during the coexistence period.

21. A network entity configured for wireless communications, comprising: a memory comprising processor-executable instructions; and a processor configured to execute the processor-executable instructions and cause the network entity to:
send, to a user equipment, a configuration for a coexistence period during which transmission over a first wireless communication band is deprioritized and downlink communication over a second wireless communication band, different from the first wireless communication band, is prioritized.

22. The network entity of claim 21, wherein the processor is further configured to cause the network entity to send, to the user equipment, during the coexistence period, downlink communication over the first wireless communication band.

23. The network entity of claim 21, wherein the processor is further configured to cause the network entity to receive, from the user equipment, a requested configuration for the coexistence period.

24. The network entity of claim 23, wherein the processor is further configured to cause the network entity to modify the requested configuration for the coexistence period to generate the configuration for the coexistence period sent to the user equipment.

25. The network entity of claim 21, wherein the configuration for the coexistence period comprises an indication configured to be used by the user equipment for selecting the configuration from a plurality of pre-configured configurations.

26. The network entity of claim 21, wherein the processor is further configured to cause the network entity to select the configuration for the coexistence period based on one or more of:
network traffic associated with the user equipment;
a quality of service (QoS) requirement associated with the user equipment;
an availability of positioning data from a positioning system;
a quality of a signal bearing positioning data received by the user equipment;
an availability of location data for a mobile entity of a positioning system;
mobility information regarding the user equipment;
location information regarding the user equipment;
an authentication status associated with a positioning system; or
an operational state of the user equipment.

27. The network entity of claim 21, wherein the processor is further configured to cause the network entity to receive, from the user equipment, timing information related to a transmission from the user equipment over a first wireless communication band.

28. The network entity of claim 21, wherein the coexistence period is defined by one or more of:
a periodicity of the coexistence period;
a time offset of the coexistence period; or
a duration of the coexistence period.

29. The network entity of claim 21, wherein:
the first wireless communication band is an L band, and
the second wireless communication band is a global navigation satellite system (GNSS) communication band.

30. A method for reducing wireless interference, comprising sending, to a user equipment, a configuration for a coexistence period during which transmission over a first wireless communication band is deprioritized and downlink communication over a second wireless communication band, different from the first wireless communication band, is prioritized.
